(19) United States
(12) Patent Application Publication
(10) Pub. No.: US 2010/0282831 A1
(43) Pub. Date: Nov. 11, 2010

(54) RETAIL READY DISPLAY TRAY

(75) Inventors: Harry Fithian, Langhorne, PA (US); Stuart Fenkel, Penn Valley, PA (US)

Correspondence Address: BLANK ROME LLP, WATERGATE, 600 NEW HAMPSHIRE AVENUE, N.W., WASHINGTON, DC, 20037, US

(73) Assignee: McLean Packaging Corporation, Pennsauken, NJ (US)

(21) Appl. No.: 12/562,066

(22) Filed: Sep. 17, 2009

Related U.S. Application Data
(60) Provisional application No. 61/177,118, filed on May 11, 2009.

(51) Int. Cl. B65D 17/50; B31B 1/72

(52) U.S. Cl. 229/238; 493/116

(57) ABSTRACT

A container for packaging and displaying retail goods is disclosed. The container comprises a top cover portion, a bottom container portion rotatably attached to the top cover portion, and one or more tear tapes disposed between the top cover portion and the bottom container portion where the bottom container portion is attached to the top cover portion, wherein the top cover portion is configured to be held closed to the bottom container portion at one or more removable pull tabs and the top section is configured to be detachably removed from the bottom section by removing the one or more tear tapes and the one or more removable pull tabs. A method for making the container is also disclosed.

### CROSS-REFERENCE TO RELATED APPLICATION

This application claims priority to and the benefit of U.S. Provisional Patent Application No. 61/177,118 filed May 11, 2009, the entire content of which is incorporated by reference herein.

### FIELD OF THE INVENTION

The present invention relates to a new and useful method and device for packaging and displaying retail goods. More particularly, the present invention relates to a new and useful method and device for packaging and displaying retail goods without the need for cutting tools to open the packaging.

### BACKGROUND OF THE INVENTION

Containers for retail goods typically are manufactured using fold-and-glue production line techniques, wherein one or more pieces of flat corrugated kraft and/or paperboard stock are die cut into shapes that define various panels. Preferential fold lines are formed in the various panels by perforations, knife slits, or scores during that process so that, when folded along those lines, the various panels will define the top, bottom, and sides of the container as well as any internal reinforcing and/or partitioning structures that are needed to form the particular container. When more than one discrete piece is needed to make up all of the structural components of a container, adhesive may be applied to limited areas of some of the pieces where those pieces are to be attached to other pieces. Then, as the various pieces are brought together, guides and rollers hold and fold over certain portions of the panels in a predetermined order to adhere those pieces together at those limited areas. Some of the panels that are not glued may also be folded during that process so that the final container may be erected more easily.

The containers produced by the fold-and-glue production line process typically are provided in a collapsed, or flattened, parallelogram state known as the Knocked-Down-Flat (KDF) configuration. In that flattened state, a large volume of empty containers can be efficiently stored, handled, and shipped before, for example, a goods supplier packs them with retail goods. Then, when the goods supplier is ready to pack the containers with retail goods, each container can be erected by opening it from its KDF configuration and folding it into its final shape.

Minimizing the effort and complication required by a goods supplier to erect and close the containers when packing them typically dictates the viability and success of a particular container design. Accordingly, containers preferably consist of the minimum number of discrete pieces needed to make up the structural components of the container and are erected and closed with a minimum number of steps, or motions. Minimizing the number of discrete pieces required to make the container and the number of folds required to assemble the structure of the container reduces the number of steps required to erect and close the container. Thus, there is a need for a container with a small number of discrete pieces, that requires a minimum number of folds to assemble the container, and that requires a minimum number of steps to erect and close the container.

In addition, to reduce packaging costs and the costs associated with packing and unpacking retail goods, it has become common practice to design boxes and other containers so that the retail goods can be both shipped and displayed for sale in the same container. Some such containers have separate covers, or hoods, that are placed on the container for shipping and then removed to display the container's contents at the point-of-sale. In manufacturing such containers, it is common for a bottom corrugated section to be formed separately from a top corrugated section so that the two sections must be assembled separately, fitted together, and taped shut. The goods supplier typically tapes the cover to the container to secure it so the contents of the container are retained therein when the container is shipped from the goods supplier to retailers.

Installing and taping lids on boxes requires a significant amount of labor. And, since the cover (i.e., the top section) is often removed and thrown away, there is significant material waste associated with such containers, adding cost to the manufacturing process, which may already be complex and expensive. Moreover, the employees at a retailer must carry cutting tools, such as box cutters, to remove the tape to open the containers and display their contents at the point-of-sale. Such cutting tools can be both dangerous to use and a nuisance to carry around. Accordingly, there is also a need for a new and useful method and device for packaging and displaying retail goods that requires less labor to assemble the container, that uses fewer materials and/or less expensive materials, and that does not require the use of cutting tools to open the container or remove its cover.

### SUMMARY OF THE INVENTION

Accordingly, to solve at least the above problems and/or disadvantages and to provide at least the advantages described below, a non-limiting object of the present invention is to provide a container for packaging and displaying retail goods comprising a top cover portion, a bottom container portion rotatably attached to the top cover portion, and one or more tear tapes disposed between the top cover portion and the bottom container portion where the bottom container portion is attached to the top cover portion, wherein the top cover portion is configured to be held closed to the bottom container portion at one or more removable pull tabs and the top section is configured to be detachably removed from the bottom section by removing the one or more tear tapes and the one or more removable pull tabs. Those and other objects of the invention, as well as many of the intended advantages thereof, will become more readily apparent when reference is made to the following description, taken in conjunction with the accompanying drawings.

### BRIEF DESCRIPTION OF THE DRAWINGS

FIG. 1 is a an exploded orthogonal view illustrating a non-limiting exemplary embodiment of a retail-ready display tray according to the present invention;

FIG. 2 is a plan view illustrating a first non-limiting exemplary embodiment of a bottom component used to assemble the tray of FIG. 1;

FIG. 3 is a plan view illustrating a first non-limiting exemplary embodiment of a top component used to assemble the tray of FIG. 1;

FIG. 4 is a plan view illustrating the steps for assembling the bottom component of FIG. 2 and the top component of FIG. 3;

FIG. 5A is a top plan view illustrating the assembly of FIG. 4 in the knocked-down-flat configuration;

FIG. 5B is a bottom plan view illustrating the assembly of FIG. 4 in the knocked-down-flat configuration;

FIG. 6 is an orthogonal view illustrating a the assembly of FIGS. 5A and 5B erected into a retail-ready display tray in the opened position;

FIG. 7 is an orthogonal view illustrating the removal of pull tables and a tear tape from the tray of FIG. 6 after it has been closed and taped shut;

FIG. 8 is a plan view illustrating a second non-limiting exemplary embodiment of a bottom component used to assemble the tray of FIG. 1;

FIG. 9 is a plan view illustrating a second non-limiting exemplary embodiment of a top component used to assemble the tray of FIG. 1;

FIG. 10 is a plan view illustrating the steps for assembling the bottom component of FIG. 8 and the top component of FIG. 9;

FIG. 11A is a top plan view illustrating the assembly of FIG. 10 in the knocked-down-flat configuration;

FIG. 11B is a bottom plan view illustrating the assembly of FIG. 10 in the knocked-down-flat configuration;

FIG. 12 is an orthogonal view illustrating a the assembly of FIGS. 11A and 11B erected into a retail-ready display tray in the opened position;

FIG. 13 is a plan view illustrating a third non-limiting exemplary embodiment of a top component used to assemble the tray of FIG. 1;

FIG. 14 is a plan view illustrating the steps for assembling the bottom component of FIG. 8 and the top component of FIG. 13;

FIG. 15A is a top plan view illustrating the assembly of FIG. 14 in the knocked-down-flat configuration;

FIG. 15B is a bottom plan view illustrating the assembly of FIG. 14 in the knocked-down-flat configuration;

FIG. 16 is an orthogonal view illustrating a the assembly of FIGS. 15A and 15B erected into a retail-ready display tray in the opened position;

FIG. 17 is a plan view illustrating a fourth non-limiting exemplary embodiment of a top component used to assemble the tray of FIG. 1; and

FIG. 18 is a plan view illustrating the bottom component of FIG. 2 and formed integrally with the top component of FIG. 17.

### DETAILED DESCRIPTION OF THE INVENTION

Reference will now be made in detail to non-limiting embodiments of the present invention by way of reference to the accompanying drawings, wherein like reference numerals refer to like parts, components, and structures. In describing those non-limiting embodiments, the term “score line” is used to refer to a score, or indentation, formed in a panel that may or may not include perforations. Perforations can be added anywhere there is a score line to increase the flexibility of the panel at that score line so the panel can be folded along that score line with less force. And, the term “slit” is used to refer to a knife, or cut, in the panel that extends all of the way through the subject panel so that at least a portion of the panel can be separated along that slit.

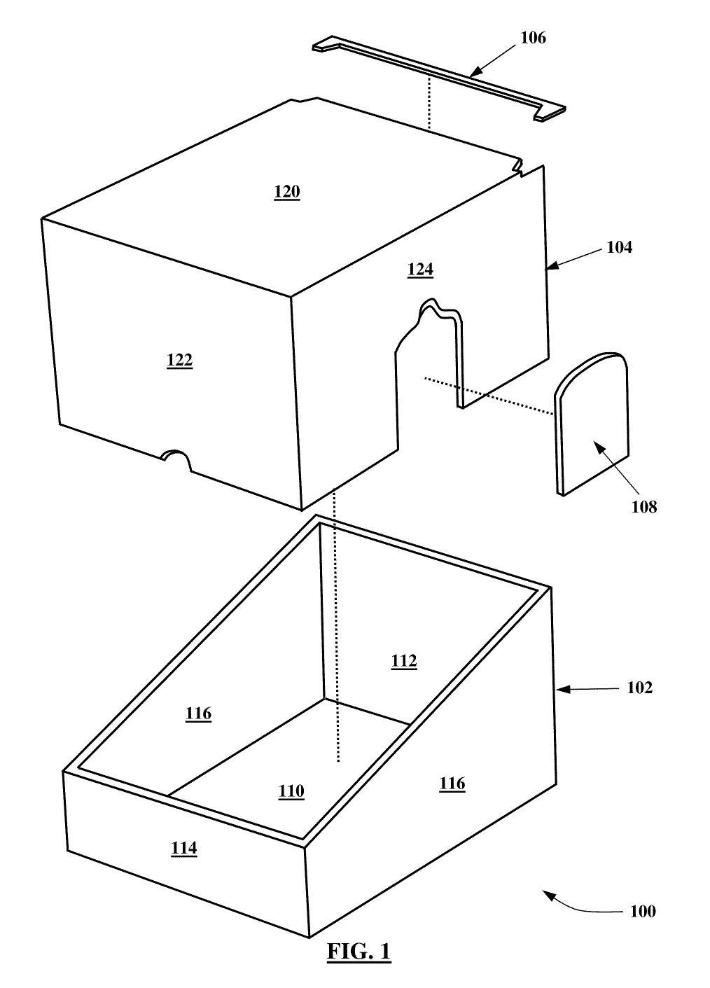

Turning to the drawings, FIG. 1 illustrates an exploded view of an exemplary embodiment of a retail-ready display tray 100 according to the present invention that addresses at least the problems described above by providing a bottom container portion 102 and a top cover portion 104 with a tear tape and at least two pull tabs 108, wherein the top cover portion 104 can be removed from the bottom container portion 102 without the need for cutting tools by merely removing the tear tape 106 and the pull tabs 108 from the top cover portion 104. The bottom container portion 102 includes a bottom panel 110, a rear panel 112, a bottom front panel 114, and bottom side panels 116 that are configured to contain and display retail goods therebetween. The rear panel 112 can be taller in height than the bottom front panel 114, and the bottom side panels 116 can decrease in height as they extend from the rear panel 112 to the bottom front panel 114 so that retail goods disposed in the bottom container portion 102 can more easily be viewed and/or accessed at the point-of-sale. And, the top cover portion 104 includes a top panel 120, a top front panel 122, and top side panels 124 that are configured to cover the bottom container portion 102 when attached thereto to hold the retail goods therein during shipping and/or storage.

The bottom container portion 102 can be formed integrally with the top cover portion 104 from the same piece of flat corrugated kraft and/or paperboard stock, or the bottom container portion 102 can be formed as a separate piece from the top cover portion 104 and joined together to form a single retail-read display tray 100 after each separate piece is formed. Forming the bottom container portion 102 integrally with the top cover portion 104 provides the advantage of requiring fewer steps to manufacture the retail-ready display tray 100 of the present invention. And, forming the bottom container portion 102 as a separate piece from the top cover portion 104 before joining them together provides the advantage of allowing the bottom container portion 102 to be made from different material than the top cover portion 104, which can help reduce manufacturing costs. For example, the substrate of the top cover portion 104 may be formed from inexpensive kraft paper since that portion will ultimately be discarded and thrown away, and the substrate of the bottom container portion 102 may formed from a more expensive printable material for printing graphics since that portion will be used to display retail goods at the point-of-sale. The bottom container portion 102 and the top cover portion 104 can be manufactured in several different configurations without departing from the spirit of the present invention.

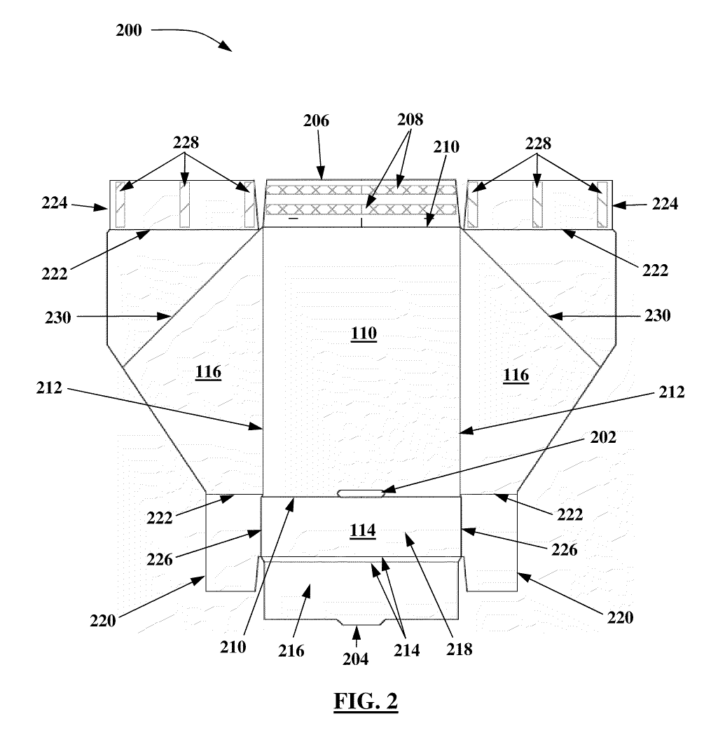

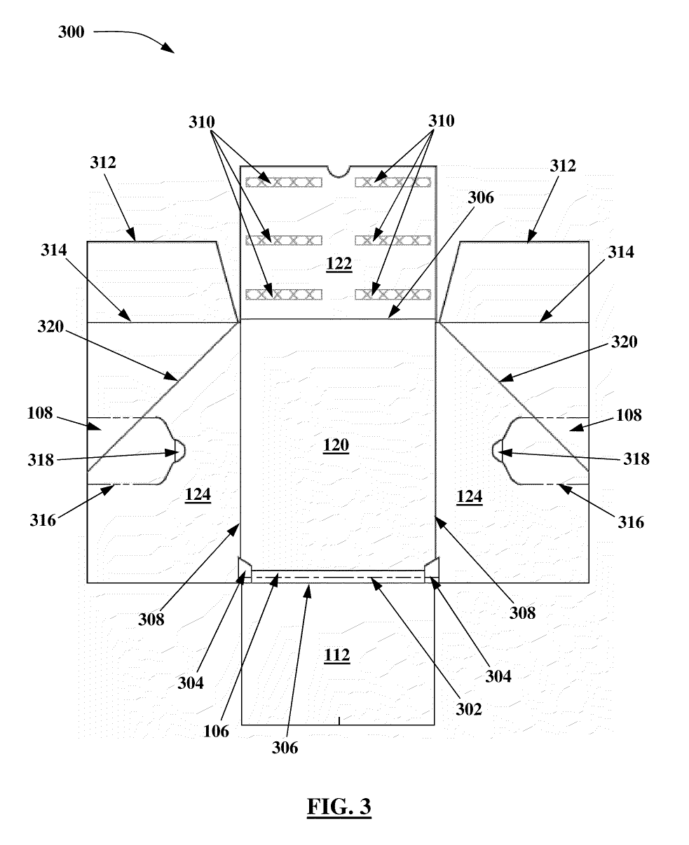

FIG. 2 illustrates one non-limiting embodiment of a bottom component 200 for forming the bottom container portion 102 of a two-piece retail-ready display tray 100 according to the present invention. The bottom component 200 includes the bottom panel 110, the bottom front panel 114, and the bottom side panels 116 of the bottom container portion 102 integrally formed from a single piece of flat corrugated kraft and/or paperboard stock. The bottom panel 110 is formed with at least one longitudinal engagement opening 202 for receiving a longitudinal engagement tab 204 formed on the bottom front panel 114 when the bottom front panel 114 is folded over onto itself and erected. The bottom panel 110 is also formed with a first attaching tab 206 for attaching the rear panel 112 on the top component 300 (FIG. 3) to the bottom component 200 with an attaching means 208, such as an adhesive or mechanical fastener. Longitudinal score lines 210 are provided in the bottom component 200 between the bottom panel 110 and the bottom front panel 114 and between the bottom panel 110 and the first attaching tab 206 so the bottom front panel 114 and first attaching tab 206 can be folded along those longitudinal score lines 210, respectively, to extend substantially perpendicular to the bottom panel 110 when the retail-ready display tray 100 is erected from the KDF configuration. And, latitudinal score lines 212 are disposed in the bottom component 200 between the bottom panel 110 and the bottom side panels 116 so the bottom side panels 114 can be folded along those latitudinal score lines 212 to extend substantially perpendicular to the bottom panel 110 when the retail-ready display tray 100 is erected from the KDF configuration.

The bottom front panel 114 includes a pair of longitudinal score lines 214 disposed substantially in the center thereof so that the bottom front panel 114 can be folded over onto itself such that an inner portion 216 of the bottom front panel 114 overlaps an outer portion 218 of the bottom front panel 114. When the bottom front panel 114 is folded over onto itself, the longitudinal engagement tab 204 is inserted into the longitudinal engagement opening 202 to hold the bottom front panel 114 in the folded-over position. The longitudinal score lines 214 are spaced apart a distance approximately equal to the thickness of a pair of fold-over tabs 220 on the bottom side panels 116 so those fold-over tabs 218 can be held between the inner portion 216 and outer portion 218 of the bottom front panel 114 when the bottom front panel 114 is folded over onto itself.

The bottom side panels 116 each include longitudinal score lines 222 that define a fold-over tab 220 and a second attaching tab 224. Each fold-over tab 220 is separated from the bottom front panel 114 by a latitudinal slit 226 so the fold-over tab 220 can be folded at its respective longitudinal score line 222 to extend substantially perpendicular to the bottom side panel 116 before the bottom side panel 114 is folded about its respective latitudinal score line 212 to extend substantially perpendicular to the bottom panel 110. Each second attaching tab 224 can be folded along its respective longitudinal score line 222 to extend substantially perpendicular to the bottom side panel 116 after the bottom side panel 116 is folded about its respective latitudinal score line 212 to extend substantially perpendicular to the bottom panel 110. And, each second attaching tab 224 includes attaching means 228, such as an adhesive or mechanical fastener, for attaching the rear panel 112 to the bottom component 200 when the retail-ready display tray 100 is assembled. The bottom side panels 116 also each include a diagonal score line 230 so the rear panel 112 can be collapsed forward (i.e., toward the bottom front panel 114) to lay flush with the bottom panel 110 of the bottom component 200 before being attached to the first attaching tab 206 and second attaching tabs 222. That diagonal score line 230 thereby allows the assembled retail-ready display tray 100 to be assembled in a KDF configuration.

FIG. 3 illustrates one non-limiting embodiment of a top panel 300 for forming the top cover portion 104 of a two-piece retail-ready display tray 100 according to the present invention. The top component 300 illustrated in FIG. 3 is configured to be assembled with the bottom component 200 illustrated in FIG. 2 to form a complete retail-ready display tray 100. The top component 300 includes the rear panel 112 of the bottom container portion 102 and the top panel 120, top front panel 122, and top side panels 124 of the top cover portion 104 integrally formed from a single piece of flat corrugated kraft and/or paperboard stock. The top panel 120 is formed with the pull tape 106 disposed therein where the rear panel 112 extends from the top panel 120 so the top panel 120, top front panel 122, and top side panels 124 can be detachably separated from the rear panel 112 and the bottom container portion 102 when the pull tape 106 is removed, or torn from, the top panel 120.

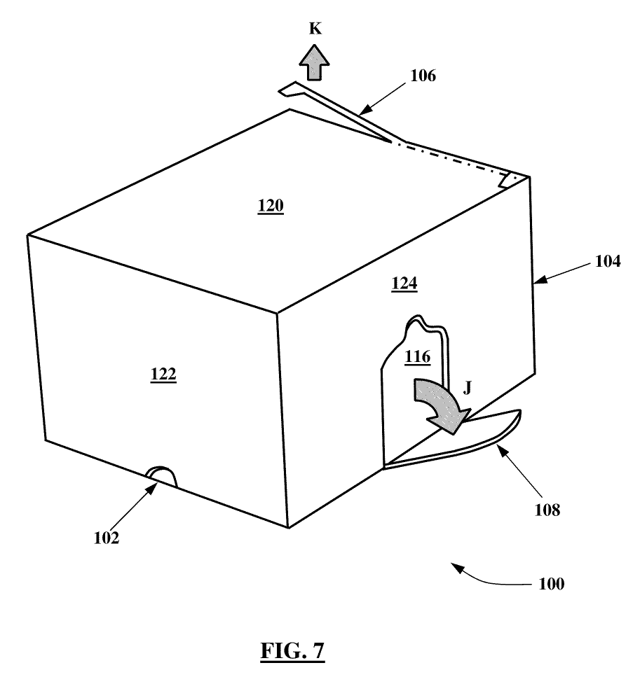

The pull tape 108 includes a reinforcing structure 302, such as a nylon ribbon, adhered to or disposed within the tear tape 108 to reinforce the tear tape 108 and to control the direction in which the top panel 120 is torn as the tear tape 108 is removed. The tear tape 108 also includes graspable ends 304 formed in the top panel 120 so that a user, such as retail store employee, can easily grip the pull tape 108 and remove it from the top panel 120. The pull tape 108 is removed, or torn, from the top panel 120 by pulling at least one of the graspable ends 304 in a direction substantially perpendicular to and away from the top panel 120 (See, e.g., FIG. 7, arrow “K”). Removing the pull tape 108 from the top panel 120 separates the top cover portion 104 from the bottom container portion 102 at the rear panel 112.

The top component 300 also includes longitudinal score lines 306 disposed between the top panel 120 and the top front panel 122 and between the top panel 120 and the rear panel 112 so the top front panel 122 and rear panel 112 can be folded along those longitudinal score lines 306, respectively, to extend substantially perpendicular to the top panel 120 when the retail-ready display tray 100 is erected from the KDF configuration. And, the top component 300 includes latitudinal score lines 308 disposed between the top panel 120 and the top side panels 124 so the top side panels 124 can be folded along those latitudinal score lines 308 to extend substantially perpendicular to the top panel 120 when the retail-ready display tray 100 is erected from the KDF configuration.

The rear panel 112 is substantially rectilinear. And, the top front panel 122 is also substantially rectilinear and includes attaching means 310, such as an adhesive or mechanical fastener, for attaching to a pair of third attaching tabs 312 on the top side panels 124. The top side panels 124 each include longitudinal score lines 314 that define the third attaching tabs 312 so each third attaching tab 312 can be folded at that longitudinal score line 314 to extend substantially perpendicular to the top side panel 124 when the top side panel 124 is folded about its respective latitudinal score line 308 to extend substantially perpendicular to the top panel 120.

The top side panels 124 also each include a pull tab 108 disposed therein positioned at a location on the top side panel 124 corresponding to the location where packing tape will be placed on the retail-ready display tray 100 when securing the top cover portion 104 to the bottom container portion 102 for storage and/or shipping after filling the retail-ready display tray 100 with retail goods. Accordingly, the packing tape can effectively be removed from the retail-ready display tray 100 without the need for cutting tools by simply removing the pull tabs 108 from the top side panels 124. To facilitate removal from the top cover portion 104, the pull tabs 108 are defined by perforations 316 in the top side panels 124 that allow the pull tabs 108 to support the vertical forces of the packing tape that hold the top cover portion 104 to the bottom container portion 102 but that give way to a predefined amount of lateral force so the pull tab 108 can be removed, or torn away, from to top cover portion 104. The top side panels 128 also each include a cut-out portion 318 disposed above and adjacent to each pull tab 108 so a user, such as a retail store employee, can insert a finger therein to obtain leverage on the pull tab 108 when removing the pull tab 108 from the top cover portion 104.

In addition, the top side panels 124 each include a diagonal score line 320 so the top front panel 122 can be collapsed rearward (i.e., toward the rear panel 112) to lay flush with the top panel 120 of the top component 300 before being attached to the side panel 124 at the third attaching tabs 312. That diagonal score line 320 also allows the retail-ready display tray 100 to be assembled in the KDF configuration.

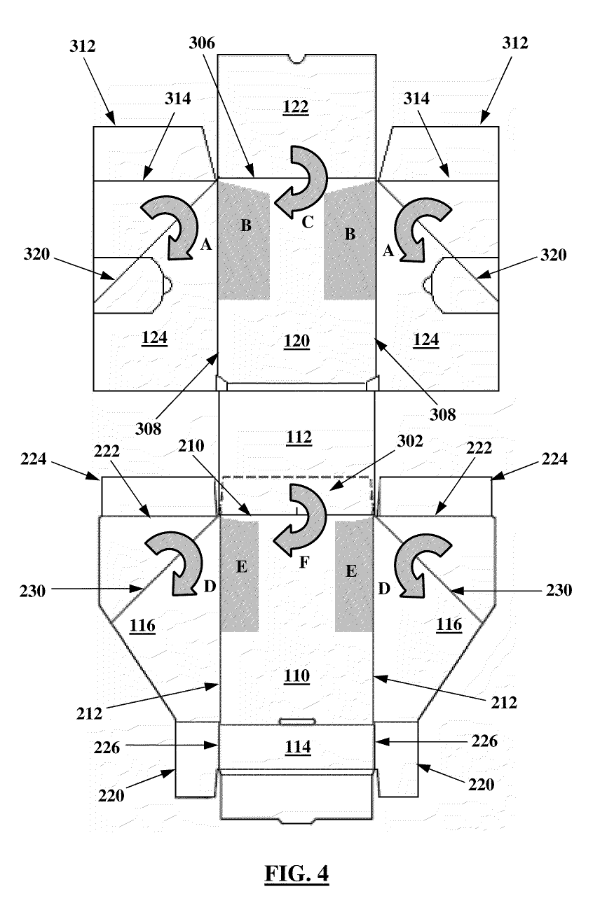

As FIG. 4 illustrates, the first step in assembling the retail-ready display tray 100 from the bottom component 200 illustrated in FIG. 2 and the top component 300 illustrated in FIG. 3 is attaching the bottom component 200 to the top component 300 at the first attaching tab 206. The next step includes folding a portion of each top side panel 124 toward the top panel 120 along its respective diagonal score line 320 as shown by arrow “A” so that the third attaching tabs 312 are disposed on the top panel 120 at shaded area “B”. Then, the top front panel 122 is folded toward the top panel 120 along its respective longitudinal score line 306 as shown by arrow “C” so that the third attaching tabs 312 are disposed between the top panel 120 and the top front panel 122. The top front panel 122 is then attached to the third attaching tabs 312 with the attaching means 310 (FIG. 3) provided on the top front panel 122. Accordingly, after the top component 300 is attached to the bottom component 200, the top component 300 can be assembled with only two folds. Those folds and attachments place the top component 300 in the KDF configuration, which facilitates the assembly of the bottom component 200.

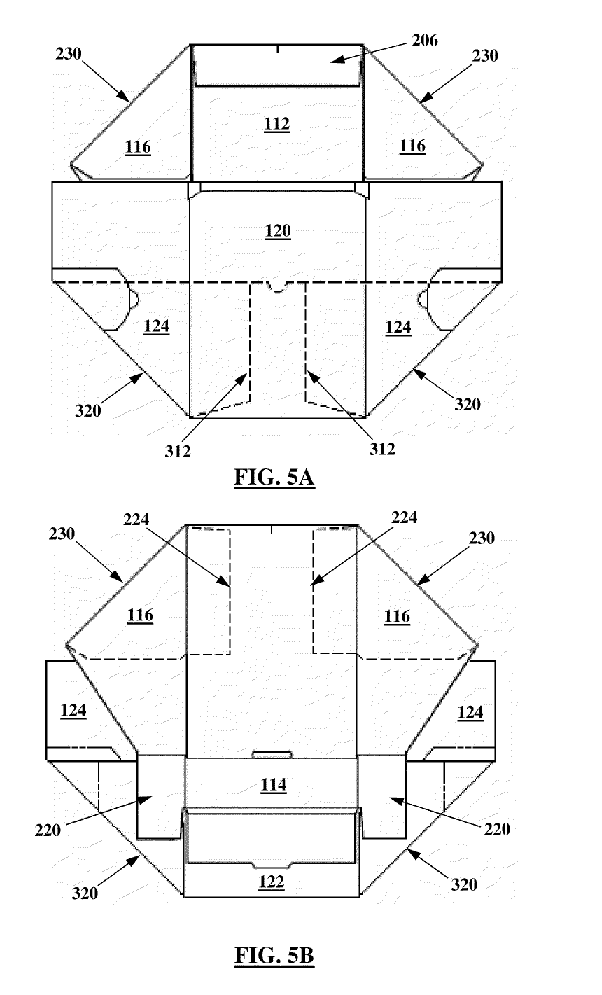

Assembling the bottom component 200 includes folding a portion of each bottom side panel 116 toward the bottom panel 110 along its respective diagonal score line 230 as shown by arrow “D” so that the second attaching tabs 224 are disposed on the bottom panel 110 at shaded area “E”. Then, the rear panel 112 is folded toward the bottom panel 110 along its respective longitudinal score line 210 as shown by arrow “F” so that the second attaching tabs 224 are disposed between the bottom panel 110 and the rear panel 112. That fold (Fold “F”) also swings the top component 300 over the bottom component 200 so the two components overlap as illustrated in FIGS. 5A and 5B. The rear panel 112 is then attached to the second attaching tabs 224 with the attaching means 228 (FIG. 2) provided on the second attaching tabs 224. Together, those folds place the bottom component 200 in the KDF configuration, which, as illustrated in FIGS. 5A and 5B, forms a completed KDF assembly 500 with the top component 300. Accordingly, the bottom component 200 can also be assembled with only two folds, and the KDF assembly 500 for an entire retail-ready display tray 100 can be assembled with only four folds.

When the retail-ready display tray 100 is assembled as described, it will be in the KDF configuration and ready for storage and/or shipping. In that configuration, the retail-ready display trays 100 have a lower profile so they can be stacked more easily for shipping to and/or storage by a user, such as a goods supplier. And, when the empty retail-ready display trays 100 reach the goods supplier, the goods supplier can erect each retail-ready display tray 100 by merely (1) pushing the rear panel rearward (i.e., away from the bottom front panel 114) so that the bottom side panels 116 are erected to a position substantially perpendicular to the bottom panel 110 as they unfold and straighten at their respective diagonal score lines 230; (2) folding the fold-over tabs 220 on the bottom side panels 116 so they extend substantially perpendicular to the erected bottom side panels 116; (3) folding the bottom front panel 114 over onto itself so the folded-over bottom front panel 114 is erected to a position substantially perpendicular to the bottom panel 110 and captures the pair of folded fold-over tabs 220 between the inner portion 216 and outer portion 218 of the bottom front panel 114; and (4) pulling the top front panel 122 forward (i.e., away from the rear panel 112) so that the top side panels 124 are erected to a position substantially perpendicular to the top panel 120 as they unfold and straighten at their respective diagonal score lines 320. The folded-over front panel 114 is held in position by inserting its longitudinal engagement tab 204 into the longitudinal engagement opening 202 in the bottom panel 110, which also helps hold the bottom side panels 116 in position by capturing the fold-over tabs 220 of the bottom side panels 116 between the interior portion 216 and exterior portion 218 of the bottom front panel 114. Accordingly, the KDF assembly 500 illustrated in FIGS. 5A and 5B can be erected into a retail-ready display tray 100 with only four motions.

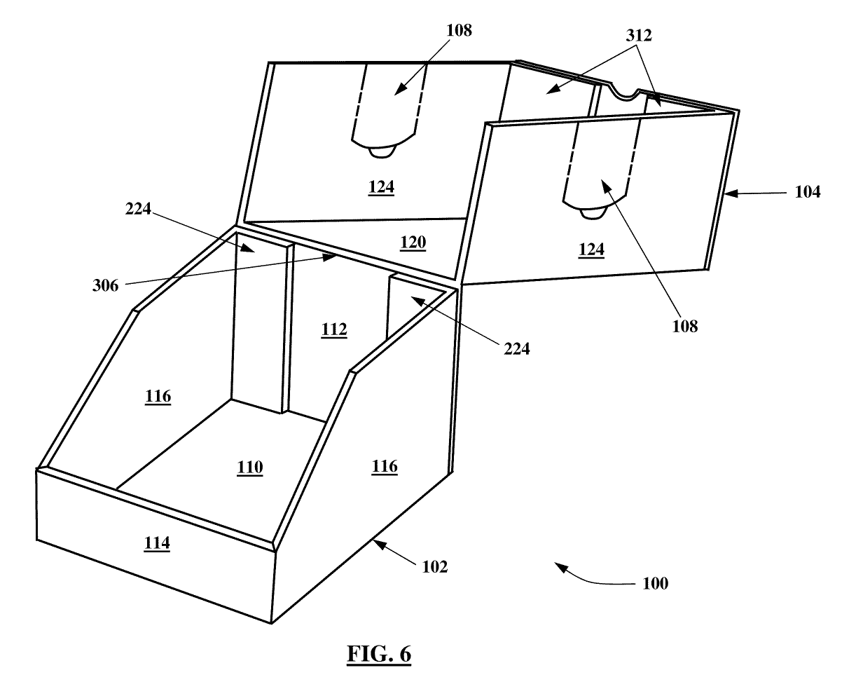

FIG. 6 illustrates a retail-ready display tray 100 erected from the assembly illustrated in FIGS. 5A and 5B. As FIG. 6 illustrates, the longitudinal score line 306 between the rear panel 112 and the top panel 120 functions like a hinge and allows the top cover portion 104 to rotate open and away from the bottom container portion 102 when the retail-ready display tray 100 is erected. That rotatable attachment allows the retail-ready display tray 100 easily to be filled with retail goods before closing it and taping it shut. The retail-ready display tray 100 can be filled with retail goods in an automated process that closes the top cover portion 104 and tapes it shut with an automatic taping machine. Due to the positioning of the pull tabs 108, the automatic taping machine will only apply packing tape to the top cover portion 104 at the pull tabs 108. With the top cover portion 104 taped to the bottom container portion 102, the retail-ready display tray 100 will retain the retail goods therein in condition suitable for shipping and/or storage. The packing and taping process may also be performed manually. Due to the substantially perpendicular top, bottom, and sides of the retail-ready display tray 100, it is particularly suited for stacking with other similar retail-ready display trays 100, such as on pallets, for shipping and/or storage.

After the retail-ready display tray 100 arrives at its destination, such as a retail store, it can be placed directly on shelves at the point-of-sale. At the point-of-sale, a retail store employee can remove the top cover portion 104 to display the retail goods contained in the retail-ready display tray 100 by simply removing the pull tabs 108 to release the packing tape from the top cover portion 104 and removing the pull tape 106 to release the top cover portion 104 from the rear panel 112 of the bottom container portion 102. As FIG. 7 illustrates, the pull tabs 108 are removed by pulling them as shown by arrow “J” and the tear tape 106 is removed by pulling it by one of its graspable ends 304 as shown by arrow “K”. Accordingly, no cutting tools are needed to remove the top cover portion 104 from the bottom container portion 102 in the retail-ready display tray 100 of the present invention. Moreover, the removed pull tabs 108 provide a graspable mechanism for a user to pull and remove the packing tape from the retail-ready display tray 100 altogether.

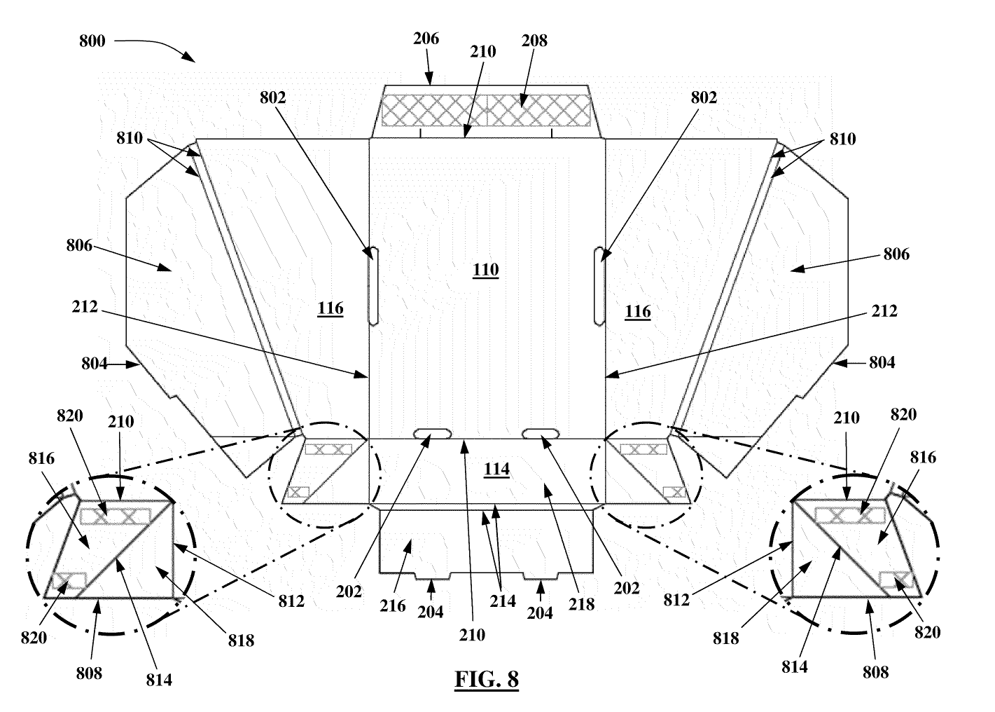

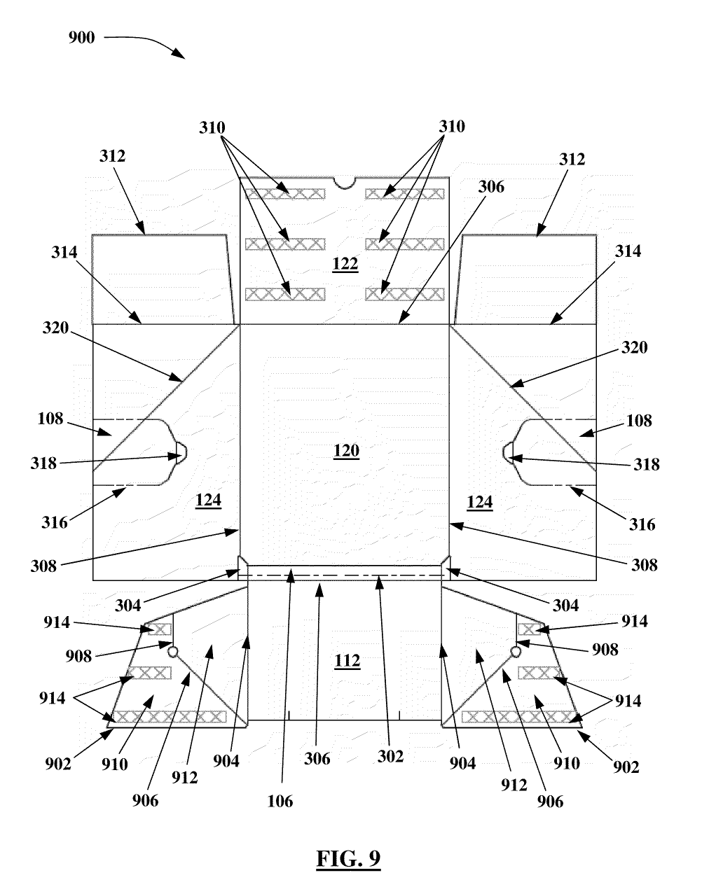

FIG. 8 illustrates another non-limiting embodiment of a bottom component 800 for forming the bottom container portion 102 of a two-piece retail-ready display tray 100 according to the present invention. The bottom component 800 illustrated in FIG. 8 is substantially the same as the bottom component 200 illustrated in FIG. 2, except that the bottom component 800 illustrated in FIG. 8 includes additional structure for providing additional structural support to the bottom container portion 102. For example, the bottom panel 110 further includes a second longitudinal engagement opening 202 for receiving a second longitudinal engagement tab 204 disposed on the bottom front panel 114 and a pair of latitudinal engagement openings 802 for receiving a pair of corresponding latitudinal engagement tabs 804 disposed on rollovers 806 on the bottom side panels 116. In addition, a pair of first gusset fold joints, or bellows tabs, 808 extend between the bottom side panels 116 and the bottom front panel 114. And, because additional structure in the corresponding top component 900 (FIG. 9) performs a similar function to the second attaching tabs 224, the second attaching tabs 224 are not required in this embodiment of the bottom component 800. The additional structure helps the bottom container portion 102 hold more weight in the retail-ready display tray 100 as well as support more weight when the retail-ready display trays are stacked for storage and/or shipping. And, by attaching the bottom front panel 114 to the side panel 116 with the bellows tab 808, the bottom front panel 114 and the side panels 116 can be erected in unison when the retail-ready display tray 100 is erected.

The rollover 806 on each bottom side panel 116 substantially doubles the width of each bottom side panel 116 and is defined by a pair of diagonal score lines 810. Those diagonal score lines 810 allow each bottom side panel 116 to be folded over onto itself so the rollover 806 overlaps the remainder of the bottom side panel 116. When each rollover 806 is folded over onto its respective bottom side panel 116, the latitudinal engagement tab 804 is inserted into the respective latitudinal engagement opening 802 in the bottom panel 110 to hold the rollover 806 in the folded-over position. The diagonal score lines 810 are spaced apart a distance approximately equal to twice the thickness of each first bellows tab 808 so that a folded-over first bellows tab 808 can be held between the rollover 806 and the remainder of the corresponding bottom side panel 116 when the rollover 806 is in the folded-over position. That distance is also approximately equal to twice the thickness of each second bellows tab 902 (FIG. 9) so that a folded-over second bellows tab 902 can also be held between the rollover 806 and the remainder of the corresponding bottom side panel 116 when the rollover 806 is in the folded-over position.

The first bellows tabs 808 extend between the bottom side panels 116 and the bottom front panel 114 on opposing sides of the bottom front panel 114. The first bellows tabs 808 are defined by the longitudinal score line 210 between the bottom panel 110 and the bottom front panel 114 and latitudinal score lines 812 extending substantially perpendicular the that longitudinal score line 210 at the sides of the bottom front panel 114. Each first bellows tab 808 includes a diagonal score line 814 that defines an inner portion 816 and an outer portion 818 of each first bellows tab 808. An attaching means 820, such as an adhesive or mechanical fastener, is provided on the inner portion 816 of each first bellows tab 808 for attaching each first bellows tab 808 to the corresponding bottom side panel 116 when the retail-ready display tray 100 is assembled. The diagonal score line 814 allows the outer portion 818 of each first bellows tab 808 to fold over onto the inner portion 816 of each first bellows tab 808 when the bottom front panel 114 is erected to extend substantially perpendicular to the bottom panel 110 while erecting the retail-ready display tray 100 from the KDF configuration. And, by attaching each first bellows tab 808 to the corresponding bottom side panel 116, the bottom front panel 114 and the side panels 116 can be erected in unison when the retail-ready display tray 100 is erected.

FIG. 9 illustrates another non-limiting embodiment of a top component 900 for forming the top cover portion 104 of a two-piece retail-ready display tray 100 according to the present invention. The top component 900 illustrated in FIG. 9 is configured to be assembled with the bottom component 800 illustrated in FIG. 8 to form a complete retail-ready display tray 100. The top component 900 illustrated in FIG. 9 is substantially the same as the top component 300 illustrated in FIG. 3, except that the top component 900 illustrated in FIG. 9 includes additional structure for providing additional structural support to the bottom container portion 102. For example, the rear panel further includes a pair of second gusset fold joints, or bellows tabs, 902. The second bellows tabs 902 not only provide additional structural support, they also cause the rear panel 112 and the top side panels 124 to be erected in unison when the second gusset tabs are attached to the side panels 124 and the retail-ready display tray 100 is erected.

The second bellows tabs 902 are provided at the sides of the rear panel 112 and are defined by latitudinal score lines 904 extending substantially perpendicular to the longitudinal score line 306 between the rear panel 112 and the top panel 120. Each second bellows tab 902 includes a diagonal score line 906 and a latitudinal slit 908 that define an inner portion 910 and an outer portion 912 of each second bellows tab 902. An attaching means 914, such as an adhesive or mechanical fastener, is provided on the inner portion 910 of each second bellows tab 902 for attaching each second bellows tab 902 to the corresponding top side panel 124 when the retail-ready display tray 100 is assembled. The diagonal score line 906 and latitudinal slit 908 allow the outer portion 912 of each second bellows tab 902 to fold over onto the inner portion 910 of each second bellows tab 902 when the rear panel 112 is erected to extend substantially perpendicular to the bottom panel 110 while erecting the retail-ready display tray 100 from the KDF configuration. The latitudinal slit 908 allows the outer portion 912 of each second bellows tab 902 to break away from inner portion 910 of each second bellows tab 902 at the latitudinal slit 908 when the rear panel 112 is erected to extend substantially perpendicular to the bottom panel 110 so that the diagonal score line 906 does not need to extend all of the way across the second bellows tab 902. That arrangement of the diagonal score line 906 and latitudinal slit 908 allow the inner portion 910 of each second bellows tab 902 to have more surface area for applying the adhesive means 914, which provides for stronger structural attachment when the inner portion 910 of each second bellows tab 902 is attached to its respective top side panel 124.

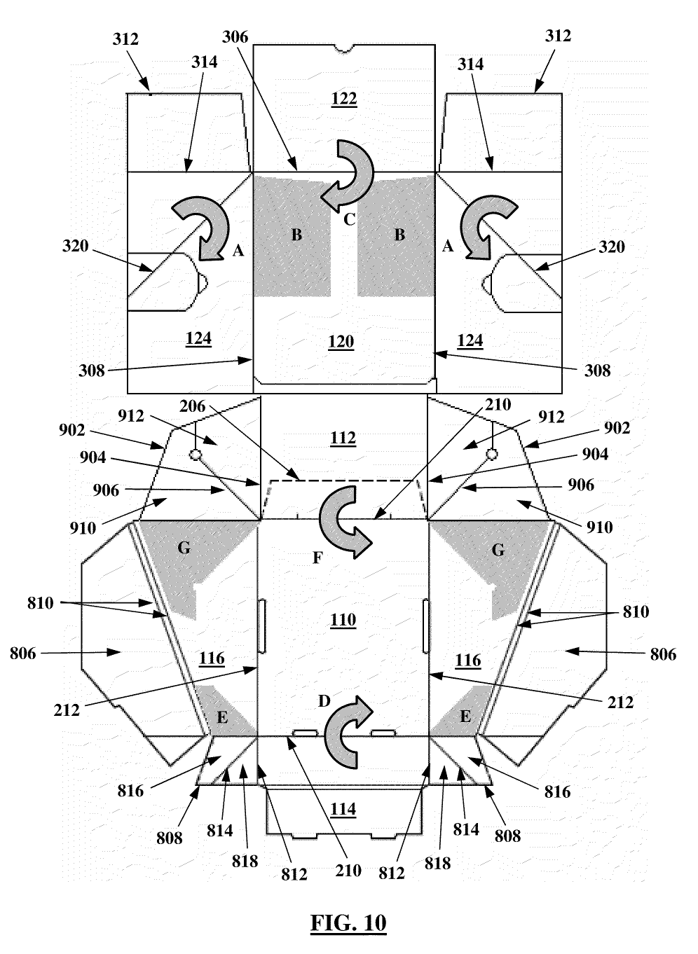

As FIG. 10 illustrates, the first step in assembling a retail-ready display tray 100 from the bottom component 800 illustrated in FIG. 8 and the top component 900 illustrated in FIG. 9 is attaching the bottom component 800 to the top component 900 at the first attaching tab 206. The next step includes folding a portion of each top side panel 124 toward the top panel 120 along its respective diagonal score line 320 as shown by arrow “A” so that the third attaching tabs 312 are disposed on the top panel 120 at shaded area “B”. Then, the top front panel 122 is folded toward the top panel 120 along its respective longitudinal score line 306 as shown by arrow “C” so that the third attaching tabs 312 are disposed between the top panel 120 and the top front panel 122. The top front panel 122 is then attached to the third attaching tabs 312 with the attaching means 310 (FIG. 9) provided on the top front panel 122. Those folds place the top component 900 in the KDF configuration, which facilitates the assembly of the bottom component 800. Accordingly, after the top component 900 is attached to the bottom component 800, the top component 900 can be assembled with only two folds.

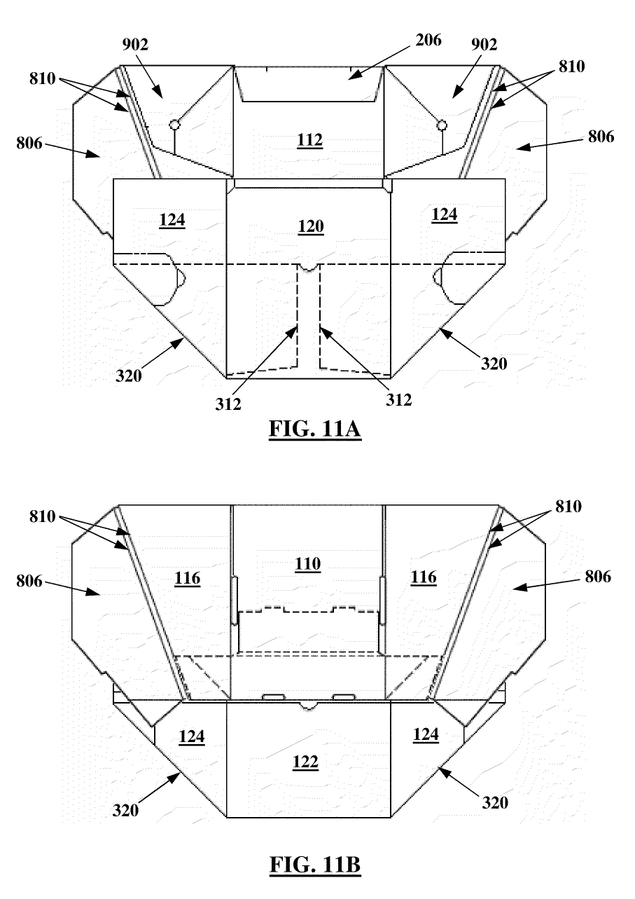

Assembling the bottom component 800 includes folding the bottom front panel 114 toward the top panel 110 and each first bellows tab 808 toward its respective bottom side panel 116 along longitudinal score line 210 as shown by arrow “D”. Then, the inner portion 816 of each first bellows tab 808 is attached to its respective bottom side panel 116 with the attaching means 820 (FIG. 8) at area “E” on each bottom side panel 116. Next, the rear panel 112 is folded toward the top panel 110 along longitudinal score line 210 as shown by arrow “F”, which also moves the second bellows tabs 902 toward their respective bottom side panels 116. That fold (Fold “F”) also swings the top component 900 over the bottom component 800 so the two components overlap as illustrated in FIGS. 11A and 11B. The inner portion 910 of each second bellows tab 902 is then attached to its respective bottom side panel 116 with the attaching means 914 (FIG. 9) at area “G” on each bottom side panel 116. Together, those folds place the bottom component 800 in the KDF configuration, which, as illustrated in FIGS. 11A and 11B, forms a completed KDF assembly 1100 with the top component 900. Accordingly, the bottom component 800 can also be assembled with only two folds, and the KDF assembly 1100 for an entire retail-ready display tray 100 can be assembled with only four folds.

When the retail-ready display tray 100 is assembled as described, it will be in the KDF configuration and ready for storage and/or shipping, which, as described above, gives it a lower profile so several retail-ready display trays 100 can be stacked more easily for shipping to and/or storage by a user, such as a goods supplier. And, when the empty retail-ready display trays 100 reach the goods supplier, the goods supplier can erect each retail-ready display tray 100 by merely (1) pushing the rear panel rearward (i.e., away from the bottom front panel 114) so that the outer portion 818 of each first bellows tab 808 folds over onto the inner portion 816 of each first bellows tab 808 and the outer portion 912 of each second bellows tab 902 folds over onto the inner portion 910 of each second bellows tab 902 as the bottom side panels 116 are pulled by the first bellows tabs 808 and second bellows tabs 902 into a position substantially perpendicular to the bottom panel 110; (2) folding the bottom front panel 114 over onto itself so the inner portion 216 overlaps the outer portion 218 and the bottom front panel 114 is erected to a position substantially perpendicular to the bottom panel 110; (3) folding the rollovers 806 on each bottom side panel 116 toward the bottom panel 110 so they overlap the remainder of their respective bottom side panels 116 and capture the respective folded-over first bellows tabs 808 and folded-over second bellows tabs 902 therebetween; and (4) pulling the top front panel 122 forward (i.e., away from the rear panel 112) so that the top side panels 124 are erected to a position substantially perpendicular to the top panel 120 as they unfold and straighten at their respective diagonal score lines 320. The folded-over front panel 114 is held in position by inserting its pair of longitudinal engagement tabs 204 into the corresponding pair of longitudinal engagement openings 202 in the bottom panel 110. And, the folded-over rollovers 806 are held in position by inserting their respective latitudinal engagement tabs 804 into the corresponding latitudinal engagement openings 802 in the bottom panel 110, which also helps hold the bottom side panels 116 in position by capturing the folded-over first bellows tabs 808 and folded-over second bellows tabs 902 between each rollover 806 and the remainder of their respective bottom side panels 116. Accordingly, the KDF assembly 1100 illustrated in FIGS. 11A and 11B can be erected into a retail-ready display tray 100 with only four motions.

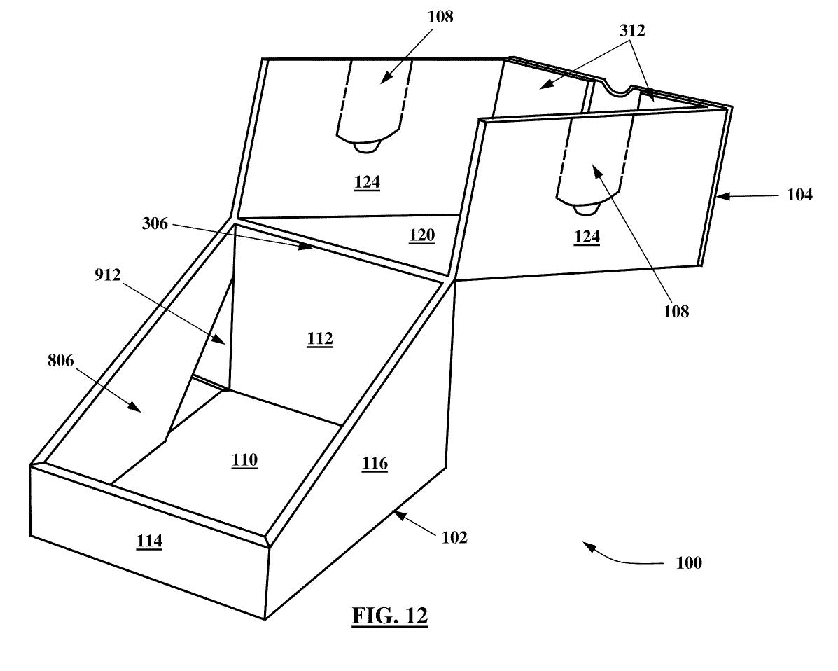

FIG. 12 illustrates a retail-ready display tray 100 erected from the assembly illustrated in FIGS. 11A and 11B. That retail-ready display tray 100 functions substantially the same as described for the retail-ready display tray 100 illustrated in FIG. 6, allowing it easily to be filled with retail goods before closing it and taping it shut, and making it particularly suited for stacking with other similar retail-ready display trays 600, such as on pallets, for shipping and/or storage. The retail-ready display tray 100 illustrated in FIG. 12 also provides the same functionality as described for the retail-ready display tray 100 illustrated in FIG. 7, allowing the top cover portion 104 to be removed from the bottom container portion 102 at the point-of-sale using the tear tape 106 and pull tabs 108 without the need for cutting tools.

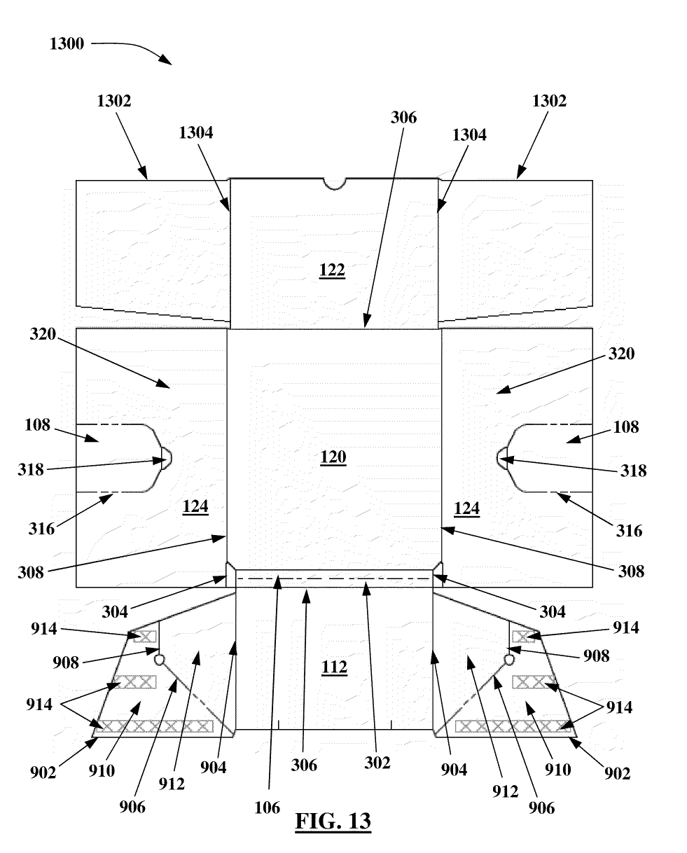

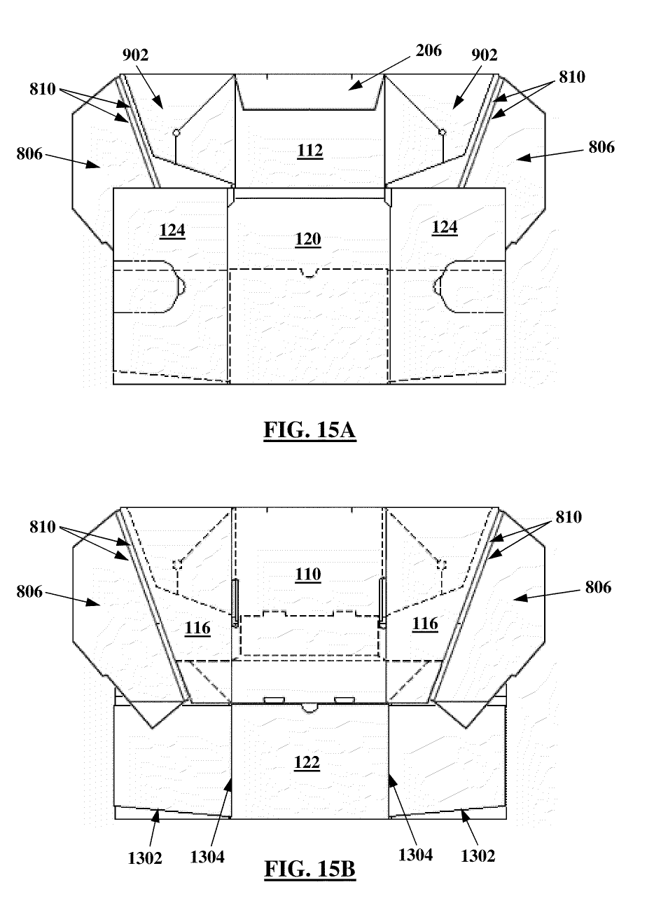

FIG. 13 illustrates yet another non-limiting embodiment of a top component 1300 for forming the top cover portion 104 of a two-piece retail-ready display tray 100 according to the present invention. The top component 1300 illustrated in FIG. 13 is configured to be assembled with the bottom component 800 illustrated in FIG. 8 to form a complete retail-ready display tray 100. The top component 1300 illustrated in FIG. 13 is substantially the same as the top component 900 illustrated in FIG. 9, except that the top component 1300 illustrated in FIG. 13 includes top side panels 124 without second attaching tabs 312 or diagonal score lines 320 and a top front panel 122 with a pair of tuck tabs 1302 and without adhesive means 310. The tuck tabs 1302 extend from the sides of the top front panel 122 and are defined by latitudinal score lines 1304 extending substantially perpendicular to the longitudinal score line 306 between the top panel 120 and the top front panel 122. That change in structure allows the top component 1300 illustrated in FIG. 13 to be assembled with one less fold than the top components 300 and 900 illustrated in FIGS. 3 and 9, respectively, and allows the retail-ready display tray 100 to be erected from a KDF assembly 1500 (FIG. 15) with one less motion than the KDF assembly 500 and 1100 illustrated in FIGS. 5A and 5B and 11A and 11B, respectively.

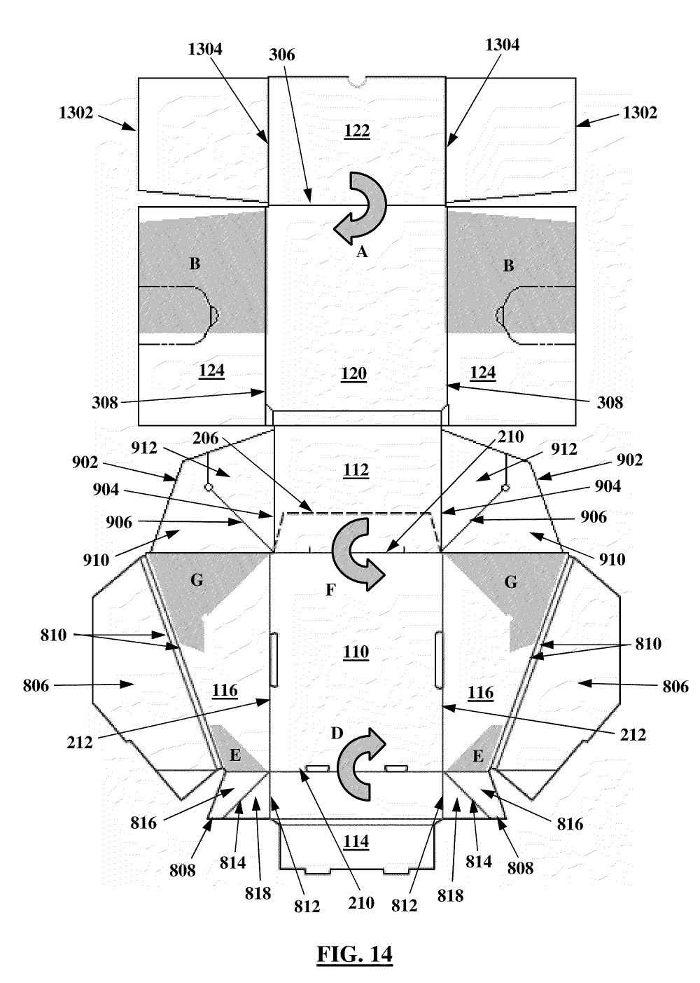

As FIG. 14 illustrates, the first step in assembling the retail-ready display tray 100 from the bottom component 800 illustrated in FIG. 8 and the top component 1300 illustrated in FIG. 13 is attaching the bottom component 800 to the top component 1300 at the first attaching tab 206. The next step includes folding the top front panel 122 toward the top panel 120 along its respective longitudinal score line 306 as shown by arrow “A” so that the tuck tabs 1302 are disposed flush with the top side panels 124 at area “B”. The tuck tabs 1302 are not attached to the top side panels 124, but are merely left flush with the top side panels 124 to position the top portion 1300 in the KDF configuration so it can be folded over onto the bottom portion 800. Thus, the top portion 1300 can be assembled with only one fold. And, the bottom component 800 can be assembled with only two folds, as described above. Together, those folds place the bottom component 800 and the top component 1300 in the KDF configuration to form a completed KDF assembly 1500, as illustrated in FIGS. 15A and 15B. Accordingly, the KDF assembly 1500 for an entire retail-ready display 100 can be assembled with only three folds.

That assembled retail-ready display tray 100 can be erected from the KDF configuration by merely (1) pushing the rear panel rearward (i.e., away from the bottom front panel 114) so that the outer portion 818 of each first bellows tab 808 folds over onto the inner portion 816 of each first bellows tab 808 and the outer portion 912 of each second bellows tab 902 folds over onto the inner portion 910 of each second bellows tab 902 as the bottom side panels 116 are pulled by the first bellows tabs 808 and second bellows tabs 902 into a position substantially perpendicular to the bottom panel 110; (2) folding the bottom front panel 114 over onto itself so the inner portion 216 overlaps the outer portion 218 and the bottom front panel 114 is erected to a position substantially perpendicular to the bottom panel 110; (3) and folding the rollovers 806 on each bottom side panel 116 toward the bottom panel 110 so they overlap the remainder of their respective bottom side panel 116 and capture the respective folded-over first bellows tabs 808 and folded-over second bellows tabs 902 therebetween. The folded-over front panel 114 is held in position by inserting its pair of longitudinal engagement tabs 204 into the corresponding pair of longitudinal engagement openings 202 in the bottom panel 110. And, the folded-over rollovers 806 are held in position by inserting their respective latitudinal engagement tabs 804 into the corresponding latitudinal engagement openings 802 in the bottom panel 110, which also helps hold the bottom side panels 116 in position by capturing the folded-over first bellows tabs 808 and folded-over second bellows tabs 902 between each rollover 806 and the remainder of its respective bottom side panel 116. Accordingly, the retail-ready display tray 100 erected from the KDF assembly 1500 illustrated in FIGS. 15A and 15B can be erected to form a retail-ready display tray 100 with only three motions.

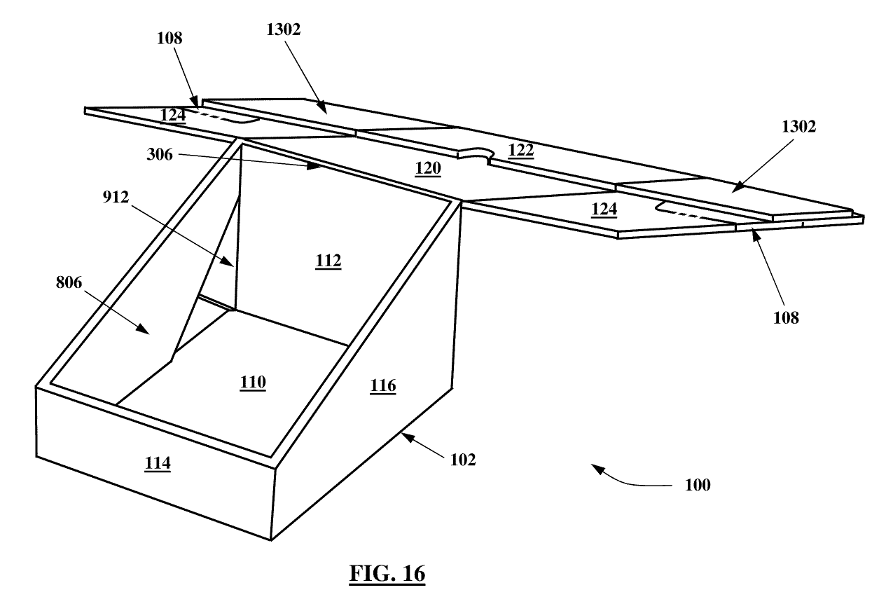

FIG. 16 illustrates a retail-ready display tray 100 erected from the assembly illustrated in FIGS. 15A and 15B. That retail-ready display tray 100 functions substantially the same as described for the retail-ready display tray 100 illustrated in FIG. 6, allowing it to easily be filled with retail goods before closing it and taping it shut, and making it particularly suited for stacking with other similar retail-ready display trays 600, such as on pallets, for shipping and/or storage. The primary distinction between the retail-ready display tray 100 illustrated in FIG. 6 and the retail-ready display tray 100 illustrated in FIG. 16 is that, when filling the latter with retail goods, the top portion 1300 requires further folding before it is closed and taped shut.

Before closing and taping the top portion 1300 shut, the top front wall 122 must be pulled forward (i.e., away from the rear panel 112) at its respective longitudinal score line 306 so it is erected to a position substantially perpendicular to the top panel 120. Next, each tuck tab 1302 must be folded rearward (i.e., toward the rear panel) at its respective latitudinal score line 1034 to a position substantially perpendicular to the erected top front wall 122. Then, top side walls 124 must be folded toward the top panel 120 at their respective latitudinal score lines 308 so they are erected to a position substantially perpendicular to the top panel 120 and flush with the respective tuck tabs 1302. With the top component 1300 in that configuration, the tuck tabs 1302 will be disposed between the top side walls 124 and the bottom side walls 116 when the top cover portion 104 is closed on the bottom container portion 102 and taped shut.

Thus, although the top component 1300 illustrated in FIG. 13 requires one less fold to assemble than the top components 300 and 900 illustrated in FIGS. 3 and 9, respectively, and allows the retail-ready display tray 100 to be erected from a KDF assembly 1500 with one less motion than the KDF assemblies 500 and 1100 illustrated in FIGS. 5A and 5B and 11A and 11B, respectively, it requires three additional folds when closing and taping the retail-ready display tray 100 shut at the goods supplier. But, by eliminating folds during assembly, the manufacturing costs are reduced for the goods supplier, particularly when those extra folds can be performed cheaply at the goods supplier. Moreover, a goods supplier may prefer the top component 1300 illustrated in FIG. 1300 because the top cover portion 104 formed from the top component 1300 illustrated in FIG. 13 is more easy to be break back down flat for disposal after it is removed from the bottom container portion 102 than the top cover portions 300 and 900 illustrated in FIGS. 3 and 9, respectively, because the top component 1300 illustrated in FIG. 13 does not have adhesive means 310 holding it together.

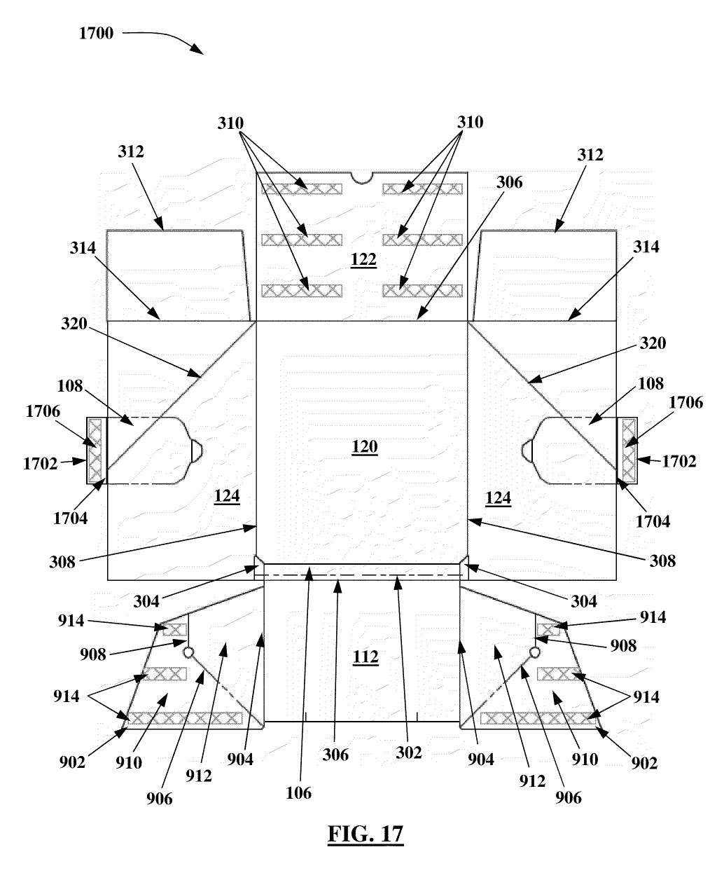

FIG. 17 illustrates yet another non-limiting embodiment of a top component 1700 for forming the top cover portion 104 of a two-piece retail-ready display tray 100 according to the present invention. The top component 1700 illustrated in FIG. 17 is configured to be assembled with the bottom component 800 illustrated in FIG. 8 to form a complete retail-ready display tray 100. The top component 1700 illustrated in FIG. 17 is substantially the same as the top component 900 illustrated in FIG. 9, except that the top component 1700 illustrated in FIG. 17 further includes fourth attachment tabs 1702 extending from the pull tabs 108. The fourth attachment tabs 1702 are defined by latitudinal score lines 1704 extending parallel to the bottom edge of each top side wall 124. The fourth attachment tabs 1702 include attaching means 1706, such as an adhesive of mechanical fastener, for attaching to the bottom of the bottom panel 110 to hold the top cover portion 104 closed on the bottom container portion 102 after the retail-ready display tray 100 erected, filled with retail goods, and closed. Accordingly, the fourth attachment tabs 1702 eliminate the need for a taping step at the goods supplier, which can further cut down on costs and labor for the goods supplier. Although the fourth attachment tabs 1702 are only described for the embodiment of the top component 17 illustrated in FIG. 17, they can be provided on any of the other top components 300, 900, and/or 1300 described herein to provide the same benefit.

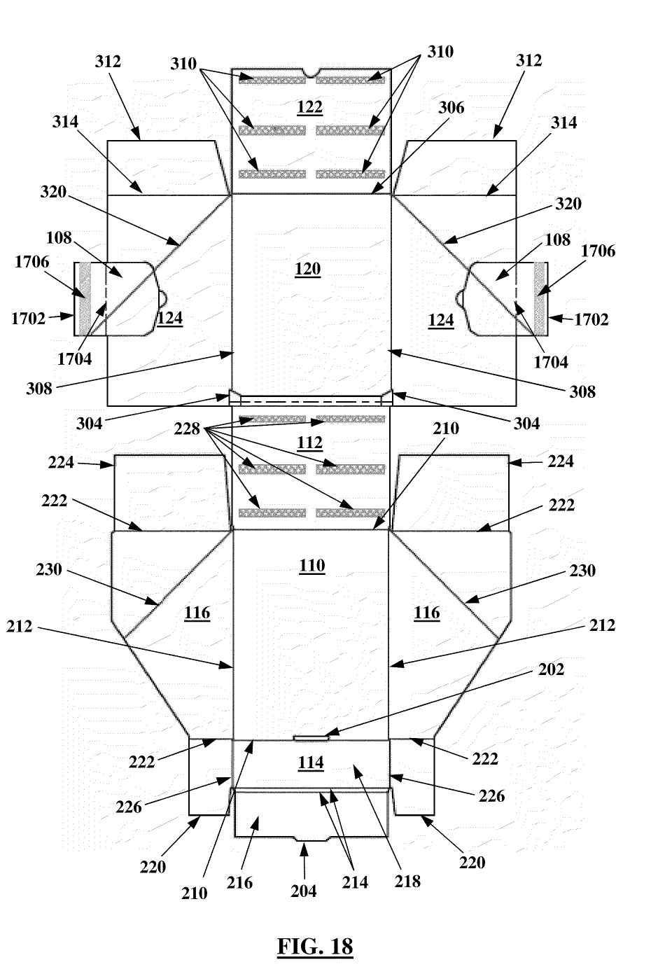

FIG. 18 illustrates the bottom component 200 illustrated in FIG. 2 formed integrally with the top component 1700 illustrated in FIG. 17 from a single piece of flat corrugated kraft and/or paperboard stock. Although FIG. 18 illustrates a combination of the bottom component 200 illustrated in FIG. 2 and the top component 1700 illustrated in FIG. 17, substantially any combination of the bottom components 200 or 800 and top components 300, 900, 1300, or 1700 described herein can be formed integrally from a single piece of flat corrugated kraft and/or paperboard stock with only slight modification to either component. Forming those two components as a single component eliminates the step of attaching the top component 300, 900, 1300, or 1700 to the bottom component 200 or 800 when assembling the retail-ready display trays 100, which reduces manufacturing costs. Moreover, forming those two components integrally as a single component eliminates the need for the first attaching tab 206, which cuts down on material costs.

When formed integrally with each other, each top component 300, 900, 1300, or 1700 and each bottom component 200 or 800 is assembled substantially the same as described above except without the step of attaching those two components together at the first attaching tab 206. And, although the assembly of the retail-ready display tray 100 is described above in a particular order for each of the different embodiments, those assemblies may take place in substantially any suitable order, whether the two components are formed integrally or separately. For example, some or all of the panels on a bottom component 200 or 800 may be folded before some or all of the panels on a top component 300, 900, 1300, or 1700 without departing from the spirit of the invention. In addition, although the adhesive means 208, 228, 310, 820, 914, and 1706 are each described as being provided on a particular panel 122 or tab 206, 224, 808, 902, or 1702, those adhesive means may also be disposed on the corresponding surface to which the particular panel or tab is attached. For example, as illustrated in FIG. 18, the adhesive means 228 is provided on the rear panel 112 instead of on the second attachment tabs 224.

Each possible configuration of the present invention provides advantages over conventional containers. Each of those configurations provides a different combination of benefits such that the different embodiments of the bottom components 200 and 800 and top components 300, 900, 1300, and 1700 can be combined in various combinations as required to suit a customer's needs. Moreover, those combinations can be provided to the customer at any state of assembly to suite a customers needs (i.e., as an un-assembled single unit (formed integrally or after being joined at the first attaching tab 206) or as a KDF assembly 500, 1100, or 1500). Combined with the time and costs savings associated with the reduced number of folds and motions for assembling and erecting the retail-ready display tray 100 of the present invention and the elimination of a need for cumbersome and dangerous cutting tools, the large number of combinations of the different embodiments of the present invention provide the additional advantages of versatility to suite individual user's needs.

The foregoing description and drawings should be considered as illustrative only of the principles of the invention. The invention may be configured in a variety of shapes and sizes and is not intended to be limited by the preferred embodiment. Numerous applications of the invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

What is claimed is:

1. A container for packaging and displaying retail goods comprising:
a top cover portion;
a bottom container portion rotatably attached to the top cover portion; and
one or more tear tapes disposed between the top cover portion and the bottom container portion where the bottom container portion is attached to the top cover portion;
wherein the top cover portion is configured to be held closed to the bottom container portion at one or more removable pull tabs and the top section is configured to be detachably removed from the bottom section by removing the one or more tear tapes and the one or more removable pull tabs.

2. The container of claim 1, wherein the bottom container portion includes a bottom panel with a pair of side panels, a bottom front panel, and a rear panel extending therefrom, and wherein the top cover portion includes a top panel with a pair of top side panels and a top front panel extending therefrom.

3. The container of claim 2, wherein the bottom container portion is configured to contain and display retail goods therein, and wherein the top cover portion is configured to cover the bottom container portion when attached thereto to hold the retail goods therein during shipping and/or storage.

4. The container of claim 2, wherein the bottom side walls further include foldover portions that fold over the bottom side walls to provide additional structural support to the bottom container portion.

5. The container of claim 2, wherein the bottom side walls further include diagonal scores that allow the top container portion to be assembled in a knocked-down-flat configuration.

6. The container of claim 2, wherein the top side walls further include diagonal scores that allow the top cover portion to be assembled in a knocked-down-flat configuration.

7. The container of claim 2, wherein the top cover portion is formed integrally with the bottom container portion.

8. The container of claim 1, wherein the tear tape includes a reinforcing structure adhered to or disposed within the tear tape to reinforce the tear tape and to control the direction in which the tear tape is torn as the tear tape is removed.

9. The container of claim 1, wherein the top cover portion is held closed to the bottom container portion by tape disposed at the one or more removable pull tabs.

10. The container of claim 1, wherein the top cover portion is held closed to the bottom container portion by an attaching means disposed on one or more attachment tabs extending from each of the one or more removable pull tabs.

11. A method for making a container for packaging and displaying retail goods comprising the steps of:
forming a top cover portion;
forming a bottom container portion;
rotatably attaching the top cover portion to the bottom container portion; and
placing one or more tear tapes between the top cover portion and the bottom container portion where the bottom container portion is attached to the top cover portion;
wherein the top cover portion is configured to be held closed to the bottom container portion at one or more removable pull tabs and the top section is configured to be detachably removed from the bottom section by removing the one or more tear tapes and the one or more removable pull tabs.

12. The method of claim 11, wherein the bottom container portion is formed with a bottom panel with a pair of side panels, a bottom front panel, and a rear panel extending therefrom, and wherein the top cover portion is formed with a top panel with a pair of top side panels and a top front panel extending therefrom.

13. The method of claim 12, wherein the bottom container portion is configured to contain and display retail goods therein, and wherein the top cover portion is configured to cover the bottom container portion when attached thereto to hold the retail goods therein during shipping and/or storage.

14. The method of claim 12, wherein the bottom side walls are formed with foldover portions that fold over the bottom side walls to provide additional structural support to the bottom container portion.

15. The method of claim 12, wherein the bottom side walls are formed with diagonal scores that allow the top container portion to be assembled in a knocked-down-flat configuration.

16. The method of claim 12, wherein the top side walls are formed with diagonal scores that allow the top cover portion to be assembled in a knocked-down-flat configuration.

17. The method of claim 12, wherein the top cover portion is formed integrally with the bottom container portion.

18. The method of claim 11, wherein the tear tape is provided with a reinforcing structure adhered to or disposed within the tear tape to reinforce the tear tape and to control the direction in which the tear tape is torn as the tear tape is removed.

19. The method of claim 11, wherein the top cover portion is held closed to the bottom container portion by tape disposed at the one or more removable pull tabs.

20. The method of claim 11, wherein the top cover portion is held closed to the bottom container portion by an attaching means disposed on one or more attachment tabs extending from each of the one or more removable pull tabs.
